(19) United States
(12) Patent Application Publication
(10) Pub. No.: US 2007/0096857 A1
(43) Pub. Date: May 3, 2007

(54) Helmholtz coil system

(75) Inventors: Winston S. Webb, Key Largo, FL (US); Erin T. Penny, Lutz, FL (US); Lance L. Sundstrom, Pinellas Park, FL (US); Robert A. Shappell JR., Pinellas Park, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/263,332

(22) Filed: Oct. 31, 2005

(51) Int. Cl. H01F 5/00

(52) U.S. Cl. 335/299

(57) ABSTRACT

An improved Helmholtz coil system is disclosed, which allows testing of components in a uniform DC or AC magnetic field with precise and repeatable positioning and orientation over 360 degrees of angular displacement about each of the x, y and z planes. For example, a 3-gimbaled Helmholtz coil system is disclosed, which includes a base plate that supports two coils arranged on a common axis and perpendicular to the base, and a system of three gimbals arranged in proximity to, but not necessarily located within, the magnetic field between the two coils. The gimbaled system includes an outer mount that is arranged perpendicular to the base plate and substantially intersects the center of the magnetic field. The gimbaled system includes three lockable gimbals, which can rotate on axes at right angles with respect to each other so as to allow a full 360 degrees of angular displacement in the x, y and z planes and also be locked for stabilization at any position therebetween. Thus, a component to be tested is secured to a plate or a test PWA attached to the inner-most or center gimbal, one or more of the three gimbals is moved and locked to position the component at a point associated with a desired set of coordinates in the x, y and z planes, and power is applied to the gimbaled Helmholtz coil system to generate a magnetic field between the two coils. Also, a set of slip rings can be provided with the gimbaled Helmholtz coil system, which enables transmission of test measurement signals from the test component to an external connection of the gimbaled Helmholtz coil system and allows more than 360 degrees of displacement of the component in any of the x, y and z planes.

### GOVERNMENT LICENSE RIGHTS

The U.S. Government may have certain rights in the present invention as provided for by the terms of Contract No. DL-H-546270 awarded by the Charles Stark Draper Laboratory.

### FIELD OF THE INVENTION

The present invention relates generally to stray magnetic field testing, and more specifically, but not exclusively, to a gimbaled Helmholtz coil system that enables testing of components in a uniform magnetic field with precise and repeatable positioning and orientation of a device under test (DUT).

### BACKGROUND OF THE INVENTION

A typical Helmholtz coil is a pair of similar coils, which are mounted on a common axis at a fixed distance apart. Essentially, passing equal currents through the two coils generates a highly uniform magnetic field within a limited space about the centroid between the coils. Thus, Helmholtz coils are ideal for use in stray magnetic field testing of a DUT, and can produce test results that are accurate and repeatable to an appreciable extent.

In this regard, a significant problem that arises with existing Helmholtz coil arrangements is that the test results are accurate and repeatable only as long as the position and orientation of the DUT can be maintained and repeated within the uniform portion of the magnetic field. To ensure maximum magnetic field uniformity across the DUT, the centroid of the DUT should be substantially positioned and maintained at the centroid of the magnetic coils. In other words, for maximum test accuracy and repeatability, the position and orientation of the DUT relative to the two coils generating the magnetic field have to be precisely maintained and repeated. Existing Helmholtz coil test arrangements provide no means for positioning and orienting a DUT between their coils. Additionally, the existing Helmholtz coil test arrangements are limited because the test wiring arrangements being used do not allow the DUT to be rotated for testing more than 360 degrees within the plane involved. Therefore, it would be advantageous to provide an improved Helmholtz coil system, which would allow testing of components in a uniform magnetic field with precise and repeatable centroid placement and angular displacement about any axis. As described in detail below, the present invention provides an improved Helmholtz coil system, which resolves the above-described DUT positioning accuracy and repeatability test problems of the existing Helmholtz coil arrangements and other related problems.

### SUMMARY OF THE INVENTION

The present invention provides an improved Helmholtz coil test system, which allows testing of a DUT in a uniform DC or AC magnetic field with precise centroid placement and angular displacement about three independent axes. In accordance with a preferred embodiment of the present invention, a Helmholtz coil with a nonmagnetic 3-gimbaled positioning system is provided, which includes a base plate that supports two coils arranged perpendicular to the base, and a system of three nonmagnetic gimbals arranged in the magnetic field between the two coils. The gimbaled system includes an outer mount that is arranged perpendicular to the base plate and substantially in the center of the magnetic field. The gimbaled system includes three lockable gimbals, which can rotate on axes at right angles with respect to each other so as to allow a full 360 degrees of angular displacement within the x, y and z planes and also be locked for stabilization at any position therebetween. Thus, in accordance with teachings of the present invention, a DUT is mounted at the center of a test printed wiring assembly (PWA) that is attached to the inner-most or center gimbal, one or more of the three gimbals is moved and locked so as to position the DUT at a desired orientation, and power is applied to the Helmholtz coil system to generate a uniform stray magnetic field around the DUT. Also, in accordance with a second embodiment of the present invention, a set of slip rings can be provided with the gimbaled Helmholtz coil positioning system, which enables transmission of test measurement signals from the DUT to an external connection of the Helmholtz coil system and allows more than 360 degrees of displacement of the component in any of the x, y and z planes. In accordance with a third embodiment of the present invention, the coil currents and gimbal positions are driven under computer control and integrated with the DUT tester to further enhance the repeatability and automation of AC and DC stray magnetic field testing in terms of applied magnetic field strength, frequency, orientation, sequence and rates of change.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIGS. 1A and 1B are related drawings that show a pictorial representation of an example gimbaled Helmholtz coil test system, which can be used to implement a preferred embodiment of the present invention;

FIGS. 2A-2F are related drawings that depict more details of the primary components of the example gimbaled Helmholtz coil test system shown in FIGS. 1A and 1B; and

FIGS. 3A and 3B are related drawings that depict a right-side view and top view, respectively, of an example gimbaled Helmholtz coil test system with three displaced gimbals, which further illustrate the example embodiment shown in FIGS. 1A and 1B.

### DETAILED DESCRIPTION OF PREFERRED EMBODIMENT

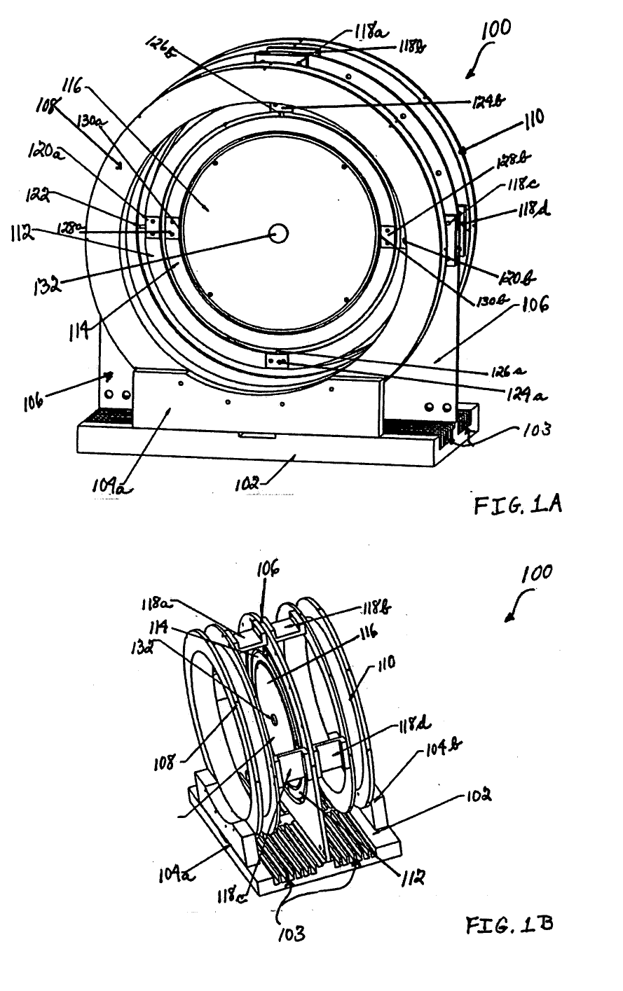

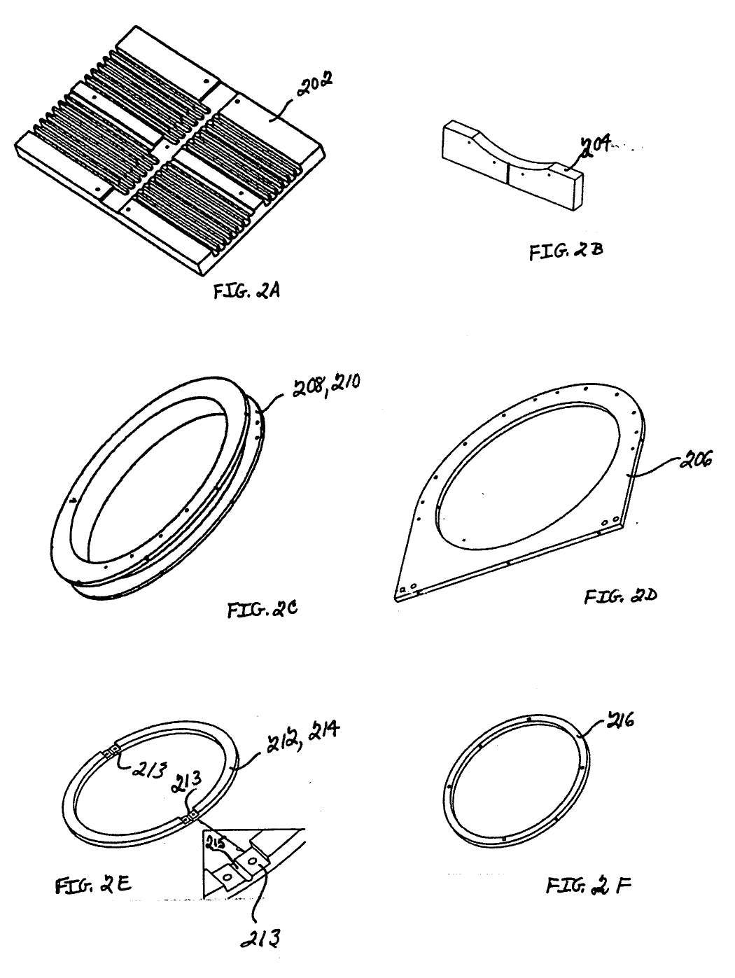

With reference now to the figures, FIGS. 1A and 1B are related drawings that show a pictorial representation of an example gimbaled Helmholtz coil system 100, which can be used to implement a preferred embodiment of the present invention. As shown, FIG. 1A depicts a perspective, front view of example gimbaled Helmholtz coil system 100, and FIG. 1B depicts system 100 in a perspective, right side view. Referring to FIG. 1A and 1B for this example embodiment, gimbaled Helmholtz coil system 100 includes a base unit 102. For clarity, a more detailed drawing of base unit 102 is depicted as base plate 202 in FIG. 2A. In any event, for this example embodiment, base unit 102 can be made of an Aluminum material, but the present invention is not intended to be so limited and can be made of any suitable material (e.g., ceramic, plastic, non-magnetic material, etc.) that does not interfere significantly with the uniformity and/or strength of the magnetic field generated by gimbaled Helmholtz coil system 100. As such, Aluminum or a similar material is preferable for base unit 102, because the high thermal conductivity of the Aluminum material serves as a heat sink to draw away and help dissipate the heat generated by the magnetic coils of gimbaled Helmholtz coil system 100. Also, as shown, a plurality of lengthwise slots 103 can be milled into base unit 102, which effectively increases the surface area of base unit 102 and enhances its cooling effectiveness. At this point, it should be understood that the present invention is not intended to be limited to the particular material used for any component of gimbaled Helmholtz coil system 100. As a practical matter, all of the major components of gimbaled Helmholtz coil system 100 may be made from the same type of suitable material (e.g., Aluminum, ceramic, plastic, non-magnetic material, etc.).

For this example embodiment, gimbaled Helmholtz coil system 100 also includes a plurality of coil ring base mount units 104a, 104b. Again, for clarity, a more detailed drawing of one example of the coil ring base mount units 104a, 104b is depicted as coil ring base mount 204 in FIG. 2B. The coil ring base mount units 104a, 104b are affixed to the upper surface of base unit 102. As shown, each coil ring base mount unit 104a, 104b is mounted substantially at the center of the upper surface of base unit 102 and flush with a respective side of base unit 102. Similar to base unit 102, the coil ring base mount units 104a, 104b can be made from an Aluminum material or a material with similar heat transference and magnetic properties as Aluminum. Preferably, the coil ring base mount units 104a, 104b are affixed to base unit 102 with non-metallic screws (e.g., plastic screws).

Gimbaled Helmholtz coil system 100 also includes a plurality of coil ring units 108, 110 affixed to respective coil ring base mount units 104a, 104b. A more detailed drawing of one example of the coil ring units 108, 110 is depicted as coil ring 208 (and 210) in FIG. 2C. As shown, the outside, bottom portion of a coil ring unit 108, 110 is affixed (e.g., preferably with non-magnetic screws) to the inside surface of a respective coil ring base mount unit 104a, 104b. Similar to the other components of gimbaled Helmholtz coil system 100, each coil ring unit 108, 110 can be made of Aluminum or a similar material. In operation, each of the coil ring units 108, 110 includes one of the coils (not shown) that make up a Helmholtz coil. Thus, applying suitable currents to the coils wound around coil ring units 108, 110 functions to generate a uniform magnetic field in the space between coil ring units 108, 110.

Notably, as a practical matter (but not intended as an architectural limitation to be imposed on the scope or coverage of the present invention), for the fabricated coils, small slots can be arranged uniformly around each of the coil ring units. These slots provide secure, accurate and uniform placement of a non-magnetic thread used in a preliminary characterization of a respective coil. Generally, it is difficult to accurately characterize the coils prior to inserting the gimbaled apparatus without such thread slots. Also, to facilitate winding of the coils and for accurate characterization of the field after the Helmholtz coils have been constructed, a bracing system can be utilized independent of the entire setup. If the coils are wound as a series connection, that is, as one long continuous piece of wire between both coils, the weight of the system and the tendency for the first coil to unravel and/or twist while winding the second coil makes winding difficult without the use of a brace. A part of the bracing system uses two small (Aluminum) rectangular pieces (not shown), which provide enhanced support during the winding process and characterization of the coils. Once the coils have been wound and are mounted on the base plate, the coils are preferably characterized prior to installation of the gimbaled apparatus. This same brace setup can be employed to support the coils during characterization.

For this example embodiment, a gimbal support unit 106 is also affixed to the upper surface of base unit 102 and arranged substantially midway between coil ring base mount units 104a, 104b. A more detailed drawing of an example of the gimbal support unit 106 is depicted as gimbal support 206 in FIG. 2D. Preferably, gimbal support unit 106 is affixed to base unit 102 with non-magnetic screws, and can be made of Aluminum or a similar material. For maximum stability, a plurality of coil supports (e.g., 118a-118d) are affixed to each coil ring unit 108, 110 and the gimbal support unit 106. Notably, referring to FIG. 1B, although only four coil supports 118a-118d are shown in the right-side view, it may be assumed that two other coil supports are each affixed to a respective coil ring unit 108, 110 and the gimbal support unit 106 on the opposite side of gimbaled Helmholtz coil system 100 and would be seen in a left-side view. The coil supports 118a-118d are preferably affixed to the coil ring units 108, 110 and the gimbal support unit 106 with non-magnetic screws, and can be made of Aluminum or a similar material. Also, although two sets of holes for connections are shown at each end of the base of gimbal support unit 106, one such set of holes may be provided, as long as the size of the holes is large enough to accommodate a suitably sized connector.

Notably, gimbaled Helmholtz coil system 100 also includes a plurality of gimbal units 112, 114, 116. For this example embodiment, gimbal unit 112 (e.g., “outer” gimbal unit) is rotatably affixed to gimbal support unit 106, gimbal unit 114 (e.g., “middle” gimbal unit) is rotatably affixed to gimbal unit 112, and gimbal unit 116 (e.g., “inner” gimbal unit) is rotatably affixed to gimbal unit 114. A more detailed drawing of an example of the outer and middle gimbal units 112, 114 is depicted as gimbal 212, 214 in FIG. 2E. A more detailed drawing of an example of the inner gimbal unit 116 is depicted as gimbal 216 in FIG. 2F. For clarity, gimbal 216 in FIG. 2F is shown without a circular plate or test PWA used for mounting a DUT (e.g., DUT 132), which covers the area circumscribed by the circumference of gimbal unit 116. Thus, as shown in FIGS. 1A and 1B, all of the gimbal units 112, 114, 116 are supported by gimbal support unit 106 and arranged substantially in the center of the uniform stray magnetic field generated by the Helmholtz coils arranged in coil ring units 108, 110. The gimbal units 112, 114, 116 can be made from Aluminum or other suitable non-magnetic materials.

For this example embodiment, the rotational positions of the gimbal units 112, 114, 116 are controlled by a combination of pins and lock tabs. For example, referring now to FIG. 2E for clarity, a pair of recesses 213 are milled into the outer gimbal and middle gimbal (e.g., gimbal units 112, 114 in FIGS. 1A and 1B). Actually, as illustrated by FIG. 1A, four such recesses are milled into the outer gimbal unit 112, and two such recesses are milled into the middle gimbal unit 114. In any event, a pin (e.g., only one pin 122 of two such pins is shown in the view of FIG. 1A) is disposed in the channel (e.g., channel 215 in FIG. 2) of each of the recesses 213. A lock tab 120a, 120b is disposed in a respective recess (e.g., 213) and affixed to the outer gimbal unit 112 preferably with non-magnetic screws. One end of each pin is fixedly attached to the gimbal support unit 106, and the other end of each pin is disposed in the channel (e.g., 215) between the respective lock tab 120a, 120b and the outer gimbal unit 112. Thus, the outer gimbal unit 112 can rotate (e.g., in two directions) about an axis formed by a straight line drawn between the two pins, and the rotational position of the outer gimbal unit 112 can be controlled by increasing or decreasing the pressure of the lock tabs 120a, 120b against the respective pins (e.g., by tightening the screws to lock the outer gimbal unit 112 in place).

Similarly, with respect to the middle gimbal unit 114, a lock tab 124a, 124b is disposed in a respective recess (e.g., 213) and affixed to the outer gimbal unit 112 (e.g., with non-magnetic screws). Each pin of a plurality of pins 126a, 126b is disposed in the channel (e.g., 215) of a respective recess 213. One end of each pin 126a, 126b is fixedly attached to the middle gimbal unit 114, and the other end of each pin is disposed in the channel (e.g., 215) between the respective lock tab 124a, 124b and the outer gimbal unit 112. Thus, the middle gimbal unit 114 can rotate (e.g., in two directions) about an axis formed by a straight line drawn between the two pins 126a, 126b, and the rotational position of the middle gimbal unit 114 can be controlled by increasing or decreasing the pressure of the lock tabs 124a, 124b against the respective pins 126a, 126b. For example, the lock tabs can be tightened to lock the position of the middle gimbal unit 114 in place.

With respect to the inner gimbal unit 116, a lock tab 128a, 128b is disposed in a respective recess (e.g., 213) and affixed to the middle gimbal unit 114 (e.g., with non-metallic screws). Each pin of a plurality of pins 130a, 130b is disposed in the channel (e.g., 215) of a respective recess 213. One end of each pin 130a, 130b is fixedly attached to the inner gimbal unit 116, and the other end of each pin is disposed in the channel (e.g., 215) between the respective lock tab 128a, 128b and the middle gimbal unit 114. Thus, the inner gimbal unit 116 can rotate (e.g., in two directions) about an axis formed by a straight line drawn between the two pins 130a, 130b, and the rotational position of the inner gimbal unit 116 can be controlled by increasing or decreasing the pressure of the lock tabs 128a, 128b against the respective pins 130a, 130b. For this example embodiment, the lock tabs can be tightened to lock the position of the inner gimbal unit 116 in place.

Notably, in accordance with a second embodiment of the present invention, a set of slip rings can be provided with the gimbaled Helmholtz coil system 100, which enables transmission of test measurement signals from a test component mounted on the inner gimbal unit to an external connection of the gimbaled Helmholtz coil system and allows more than 360 degrees of displacement of the component in any of the x, y and z planes. For example, a suitable slip ring arrangement can be substituted for each of pins 122, 126a, and 130a, which enables the three gimbal units 112, 114, 116 to be rotated and also provides a suitable signal conduction path between the inner gimbal unit 116 and the gimbal support unit 106. Thus, for this example embodiment, one or more test leads can be connected from a test component (e.g., 132) to a suitable connector mounted on the rotatable inner gimbal unit 116, and the slip rings will provide a signal conduction path from that (internal) connector via the rotatable middle and outer gimbals 114, 112, respectively, to a second (external) connector mounted on the fixed gimbal support unit 106.

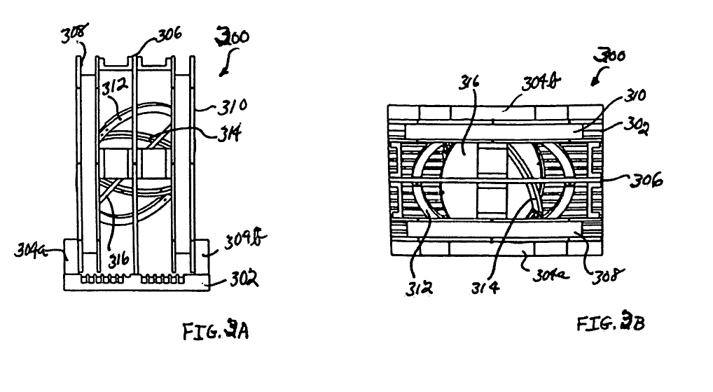

FIGS. 3A and 3B are related drawings that depict a right-side view and top view, respectively, of a gimbaled Helmholtz coil system 300 with three displaced gimbals, which further illustrate the above-described example embodiment shown in FIGS. 1A and 1B. Referring to FIGS. 3A and 3B, for this example embodiment, gimbaled Helmholtz coil system 300 includes a base unit 302, two coil ring base mount units 304a, 304b, a gimbal support unit 306, two coil ring units 308, 310, an outer gimbal unit 312, a middle gimbal unit 314, and an inner gimbal unit 316. Notably, as shown, gimbaled Helmholtz coil system 300 includes three lockable gimbal units, which can rotate on axes at right angles with respect to each other to allow a full 360 degrees of displacement in the x, y and z planes and also be locked for stabilization at any position therebetween. Thus, in accordance with teachings of the present invention, a DUT can be secured to a plate or a PWA attached to the inner gimbal unit 316, one or more of the three gimbal units 312, 314, 316 can be moved and locked so as to position the component at a point associated with a desired set of coordinates in the x, y and z planes in the space between the two coil ring units 308, 310. Then, power can be applied to the coils (not shown) disposed in the coil ring units 308, 310 in order to generate a magnetic field between the two coils.

Note that the sizes of the gimbal support and gimbals of the present invention could be increased just up to the point where the coils would interfere with gimbal rotation. This action would provide more room for a larger test PWA to be attached to the inner gimbal.

It is important to note that while the present invention has been described in the context of a fully functioning gimbaled Helmholtz coil system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular Helmholtz coil system.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. A system for positioning a component within a magnetic field, comprising:
a plurality of coil units arranged substantially in parallel, wherein said plurality of coil units are adapted to define a space associated with a magnetic field, and said space is disposed substantially between said plurality of coil units; and
a plurality of gimbal units arranged within said space disposed between said plurality of coil units, wherein a first gimbal unit of said plurality of gimbal units is adapted to rotate on an axis that is substantially perpendicular to an axis of rotation of at least a second gimbal unit of said plurality of gimbal units.

2. The system of claim 1, wherein said plurality of gimbal units comprises three gimbal units.

3. The system of claim 1, wherein said plurality of gimbal units comprises:
an outer gimbal unit rotatably attached to a gimbal support unit, a middle gimbal unit rotatably attached to said outer gimbal unit, and an inner gimbal unit rotatably attached to said middle gimbal unit; and
wherein said outer gimbal unit is adapted to rotate on an axis that is substantially perpendicular to a plane defined by said gimbal support unit, said middle gimbal unit is adapted to rotate on an axis that is substantially perpendicular to an axis of rotation of said outer gimbal unit, said inner gimbal unit is adapted to rotate on an axis that is substantially perpendicular to an axis of rotation of said middle gimbal unit, and said inner gimbal unit is adapted to mount a component for testing within said space disposed between said plurality of coil units.

4. The system of claim 1, wherein said plurality of gimbal units comprises:
an outer gimbal unit rotatably attached to a gimbal support unit, a middle gimbal unit rotatably attached to said outer gimbal unit, and an inner gimbal unit rotatably attached to said middle gimbal unit; and
wherein said outer gimbal unit is adapted to lock at a first predetermined position on a first axis that is substantially perpendicular to a plane defined by said gimbal support unit, said middle gimbal unit is adapted to lock at a second predetermined position on a second axis that is substantially perpendicular to said first axis of rotation of said outer gimbal unit, and said inner gimbal unit is adapted to lock at a third predetermined position on an axis that is substantially perpendicular to said second axis of rotation of said middle gimbal unit.

5. The system of claim 1, further comprising:
a base unit;
two coil ring base mount units fixedly attached to said base unit and separated by a predetermined distance;
a first coil unit of said plurality of coil units fixedly attached to a first coil ring base mount unit, and a second coil unit of said plurality of coil units fixedly attached to a second coil ring base mount unit;
a gimbal support unit fixedly attached to said base unit substantially midway between said two coil ring base mount units; and
wherein said plurality of gimbal units comprises:
an outer gimbal unit rotatably attached to said gimbal support unit, a middle gimbal unit rotatably attached to said outer gimbal unit, and an inner gimbal unit rotatably attached to said middle gimbal unit.

6. The system of claim 1, wherein said plurality of coil units further comprises:
means for generating said magnetic field.

7. The system of claim 1, wherein said magnetic field comprises a uniform magnetic field.

8. The system of claim 1, wherein said plurality of coil units comprises a Helmholtz coil.

9. The system of claim 1, wherein said plurality of coil units and said plurality of gimbal units are made of a non-magnetic material.

10. The system of claim 1, wherein said plurality of gimbal units comprises:
an outer gimbal unit rotatably attached to a gimbal support unit by a first slip ring unit;
a middle gimbal unit rotatably attached to said outer gimbal unit by a second slip ring unit; and
an inner gimbal unit rotatably attached to said middle gimbal unit by a third slip ring unit.

11. A gimbaled Helmholtz coil system, comprising:
means for generating a magnetic field; and
gimbal means for positioning a component within said magnetic field.

12. The system of claim 11, wherein said means for generating comprises a plurality of coils, and said gimbal means comprises a gimbal support, a first gimbal rotatably attached to said gimbal support, a second gimbal rotatably attached to said first gimbal, and a third gimbal rotatably attached to said second gimbal.

13. The system of claim 11, wherein said gimbal means comprises three rotatable gimbals, and each of said three rotatable gimbals includes locking means.

14. The system of claim 11, wherein said gimbal means comprises three rotatable gimbals, and each of said three rotatable gimbals includes slip ring means for conducting a signal between at least two of said three rotatable gimbals.

15. A method for positioning a component within a magnetic field, comprising the steps of:
arranging a plurality of coil units substantially in parallel;
adapting said plurality of coil units to define a space associated with a magnetic field, wherein said space is disposed substantially between said plurality of coil units;
arranging a plurality of gimbal units within said space disposed between said plurality of coil units;
adapting a first gimbal unit of said plurality of gimbal units to rotate on an axis that is substantially perpendicular to an axis of rotation of at least a second gimbal unit of said plurality of gimbal units; and
adapting said second gimbal unit of said plurality of gimbal units to rotate on an axis that is substantially perpendicular to an axis of rotation of at least a third gimbal unit of said plurality of gimbal units.

16. The method of claim 15, wherein said plurality of gimbal units comprises three gimbal units.

17. The method of claim 15, wherein the step of arranging said plurality of gimbal units within said space comprises the steps of:
attaching a rotatable and lockable outer gimbal unit to a gimbal support unit;
attaching a rotatable and lockable middle gimbal unit to said outer gimbal unit; and
attaching a rotatable and lockable inner gimbal unit to said middle gimbal unit.

18. The method of claim 15, wherein said magnetic field comprises a uniform magnetic field.

19. The method of claim 15, wherein said plurality of coil units comprises a Helmholtz coil.

20. The method of claim 15, wherein the step of arranging a plurality of gimbal units within said space disposed between said plurality of coil units further comprises the steps of:
attaching a first gimbal unit to a gimbal support unit by a first slip ring unit;
attaching a second gimbal unit to said first gimbal unit by a second slip ring unit; and
attaching a third gimbal unit to said second gimbal unit by a third slip ring unit.
